(19) United States
(12) Patent Application Publication
(10) Pub. No.: US 2026/0342920 A1
(43) Pub. Date: Oct. 29, 2026

(54) IMAGE PROCESSING APPARATUS, METHOD, AND STORAGE MEDIUM STORING PROGRAM

(71) Applicant: CANON KABUSHIKI KAISHA, Tokyo (JP)

(72) Inventor: YOSHITOMO WAKANA, Chiba (JP)

(21) Appl. No.: 19/650,487

(22) Filed: Apr. 17, 2026

(30) Foreign Application Priority Data
Apr. 23, 2025 (JP) 2025-071747

(51) Int. Cl. H04N 1/00; G06F 3/0482

(52) U.S. Cl. CPC H04N 1/00079; H04N 1/00037; H04N 1/00413; H04N 1/00477; G06F 3/0482; H04N 2201/0094

(57) ABSTRACT

An image processing apparatus includes: an obtaining unit configured to obtain condition information indicating a condition of each of a plurality of sections inside the image processing apparatus; and a display control unit configured to perform control to display a list screen displaying a list of the condition information obtained by the obtaining unit on a display unit. The display control unit performs control of display to enable switching between a first list screen displaying a list of the condition information together with consolidated display of the condition information so that conditions of all of the plurality of sections can be displayed, and a second list screen displaying a list of the condition information without consolidated display of the condition information.

### BACKGROUND

### Field of the Technology

The present disclosure relates to an image processing apparatus, a method, and a storage medium storing a program.

### Description of the Related Art

In a case where an image processing apparatus has a problem that the user cannot fix by themselves, a service technician may be urgently dispatched. Also, a service technician may regularly visit a user to perform maintenance on the image processing apparatus. With an urgent dispatch or a regular visit, so that the use of the image processing apparatus of the user is disturbed as little as possible, there is a need for the condition of the image processing apparatus to be quickly determined and the problem fixed. A service mode accessible only by the service technicians is one method of checking the condition of an apparatus. In the service mode, a large amount of detailed information such as the abnormal condition and wear state of the parts of the image processing apparatus and the usage history is displayed in a list. The service technician determines how to fix problems, maintenance methods, and the like based on this information.

Japanese Patent Laid-Open No. 2020-74507 describes a configuration that can switch between displaying a sender information input screen for the user to input information for creating a new years card and a preview screen with the information applied.

### SUMMARY

The present disclosure provides an image processing apparatus, a method, and a storage medium storing a program that can enhance user-friendliness in the case of displaying a list of the condition information of each of a plurality of sections inside the image processing apparatus.

The present disclosure in one aspect provides an image processing apparatus comprising: at least one memory and at least one processor which function as: an obtaining unit configured to obtain condition information indicating a condition of each of a plurality of sections inside the image processing apparatus; and a display control unit configured to perform control to display a list screen displaying a list of the condition information obtained by the obtaining unit on a display unit, wherein the display control unit performs control of display to enable switching between a first list screen displaying a list of the condition information together with consolidated display of the condition information so that conditions of all of the plurality of sections can be displayed, and a second list screen displaying a list of the condition information without consolidated display of the condition information.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a system configuration.

FIG. 2 is a diagram illustrating a configuration of an image processing apparatus.

FIG. 3 is a diagram illustrating a functional configuration of the image processing apparatus.

FIGS. 4A-4B are diagrams illustrating user interface screens.

FIGS. 5A-5B are diagrams illustrating user interface screens.

FIG. 6 is a diagram illustrating a user interface screen.

FIGS. 7A-7B are diagrams illustrating user interface screens.

FIG. 8 is a diagram illustrating a user interface screen.

FIG. 9 is a diagram illustrating data for display.

FIG. 10 is a diagram illustrating data for display.

FIG. 11 is a diagram illustrating data for display.

FIG. 12 is a diagram illustrating data for display.

FIG. 13 is a diagram illustrating data for display.

FIG. 14 is a flowchart illustrating processing in the image processing apparatus.

FIG. 15 is a flowchart illustrating processing in the image processing apparatus.

FIG. 16 is a diagram illustrating a user interface screen.

FIG. 17 is a flowchart illustrating processing in the image processing apparatus.

FIG. 18 is a flowchart illustrating processing in the image processing apparatus.

The accompanying drawings, which are incorporated in and constitute a part of the specification, illustrate embodiments of the present disclosure, and together with the description, serve to explain the principles of the embodiments.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

There is a demand for an improvement in user-friendliness when a list of condition information for each of a plurality of sections in an image processing apparatus is displayed.

According to the present disclosure, it is possible to improve user-friendliness when a list of condition information for each of a plurality of sections in an image processing apparatus is displayed.

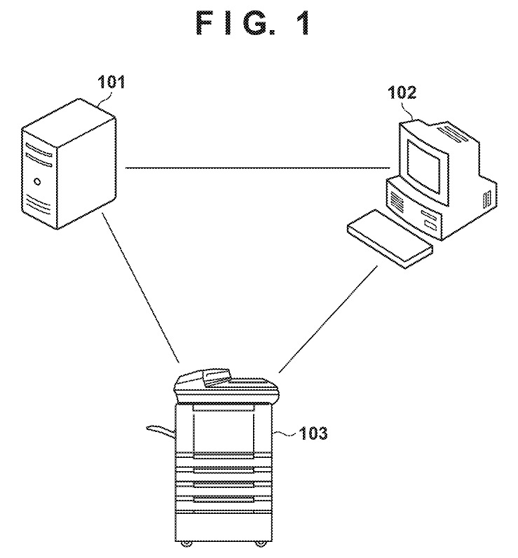

FIG. 1 is a schematic view illustrating a configuration of a system including an image processing apparatus according to the present embodiment. The system according to the present embodiment is a system including an image processing apparatus 103 connected on a network; a server personal computer (PC) 101, which is an information processing apparatus; and a client PC 102.

The image processing apparatus 103 is a printer and is a multi-function peripheral (MFP) in the present embodiment. The image processing apparatus 103 not only includes a function for copying paper documents but also includes a function for printing a print target image represented by print data transmitted from an external printer driver and a function (SEND function) for transmitting image data read from a paper document to an external file server or email address. The image processing apparatus 103 also includes a function (remote copy function, facsimile function) for transmitting data to another image processing apparatus and printing at the transmission destination image processing apparatus and the like.

The apparatuses illustrated in FIG. 1 are connected in a communication-enabling manner via a wired network, a wireless network, or a network including both. In this example, the image processing apparatus 103 is connected to an Ethernet (not illustrated). The server PC 101 and the client PC 102, which are different from the image processing apparatus 103, are each configured as a general-purpose information processing apparatus. The configuration of both apparatuses may be the same or different. Also, the configuration of the server PC 101 and the client PC 102 may be incorporated into the image processing apparatus 103, and the system of FIG. 1 may be configured as the image processing apparatus 103. Note that the information processing apparatus used in the present embodiment may be a terminal apparatus or a smartphone instead of a desktop PC. Also, the printing method of the image processing apparatus 103 used in the present embodiment may be an electro-photographic method or an inkjet printing method, or another printing method may be used.

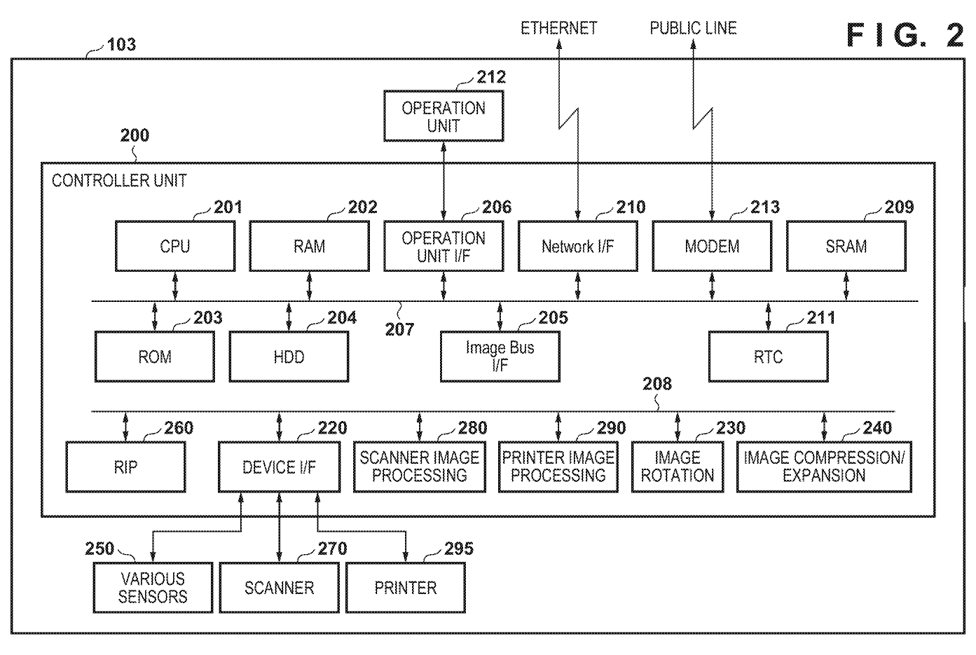

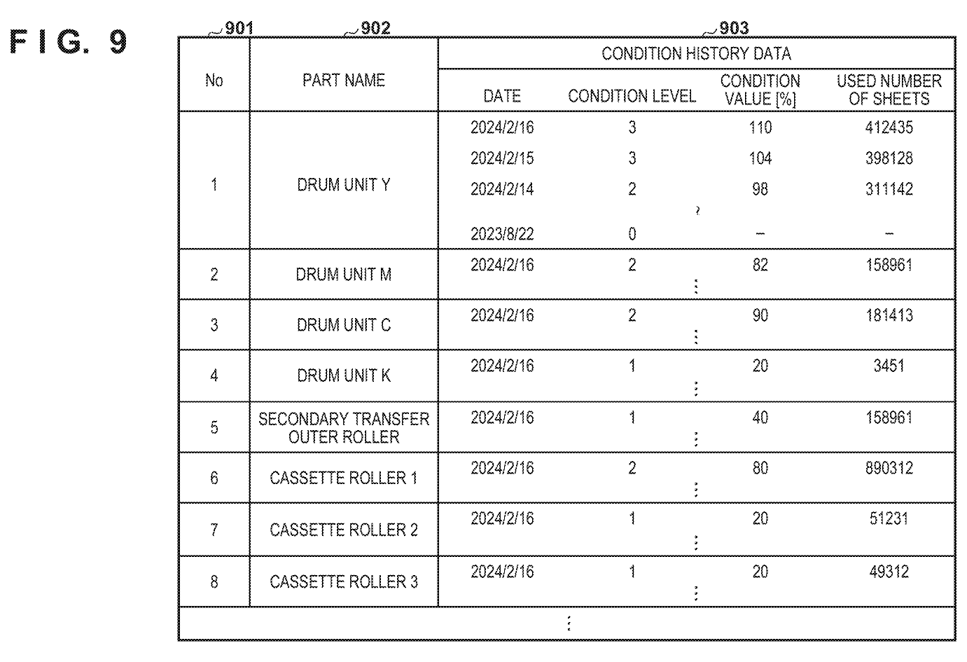

FIG. 2 is a block diagram illustrating a hardware configuration of the image processing apparatus 103 according to the present embodiment. A controller unit 200 is connected to a scanner 270 corresponding to an image input device and a printer 295 corresponding to an image output device, and performs the input and output of image information and device information via Ethernet (registered trademark) and a connection via public lines. A CPU 201 is a controller that comprehensively controls the image processing apparatus 103. A RAM 202 is a system working memory for operation of the CPU 201 and an image memory that temporarily stores image data. A ROM 203 is a boot ROM that stores the boot program of the system. A HDD 204 is a hard disk drive that stores system software programs, application programs, and image data. The HDD 204 also stores the data described below using FIGS. 9 to 13. An operation unit I/F 206, for example, outputs, to an operation unit 212 including a touch panel, image data for display on the operation unit 212. Also, the operation unit I/F 206 transfers information input by the user of the present system from the operation unit 212 to the CPU 201. The user is a service technician, for example. A network I/F 210 connects to a network and inputs and outputs information. A modem 213 is connected to a public line and inputs and outputs information. An SRAM 209 is a non-volatile storage medium capable of high-speed operation. An RTC 211 is a real time clock that executes processing of continuously counting the current time even in a state where the controller unit 200 is not supplied with power. Each device described above is connected to a system bus 207 as illustrated in FIG. 1.

An image bus I/F 205 is a bus bridge that connects the system bus 207 and an image bus 208 that transfers image data at high speeds and converts the data structure. The image bus 208, for example, is a Peripheral Component Interconnect (PCI) bus or an IEEE 1394 bus. The following devices are arranged on the image bus 208. A RIP 260 is a raster image processor that develops Page Description Language (PDL) code into a bitmap image. A device I/F 220 connects to various types of sensors 250 and obtains sensor information. Also, the device I/F 220 is an image input/output device that connects to the scanner 270, the printer 295, and the controller unit 200 and performs conversion between synchronous systems and asynchronous systems of image data. A scanner image processing unit 280 executes image processing such as correction, processing, and editing on the input image data. A printer image processing unit 290 executes image processing such as correction and resolution conversion on the print output image data. An image rotation unit 230 performs rotation of the image data. An image compression/expansion unit 240 performs compression and expansion processing.

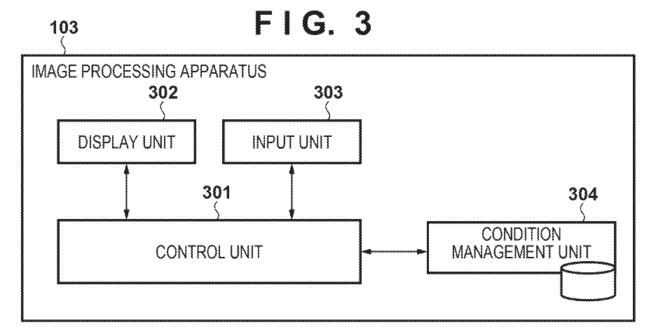

FIG. 3 is a functional block diagram illustrating the functions relating to the present embodiment in the image processing apparatus 103. The functions of each processing unit (block) illustrated in FIG. 3 are implemented by the CPU 201 executing a portion or all of the programs on the RAM 202 based on the programs stored in the ROM 203. A display unit 302 is a processing unit that displays the condition of the image processing apparatus 103 or a user interface screen such as an operation menu on the operation unit 212. An input unit 303 is a processing unit that receives operation instructions from the user. A condition management unit 304 is a processing unit that processes various information and also stores the condition of the image processing apparatus 103 in a history database (DB) configured in the HDD 204. A control unit 301 is a processing unit that controls each processing unit including the display unit 302, the input unit 303, and the condition management unit 304.

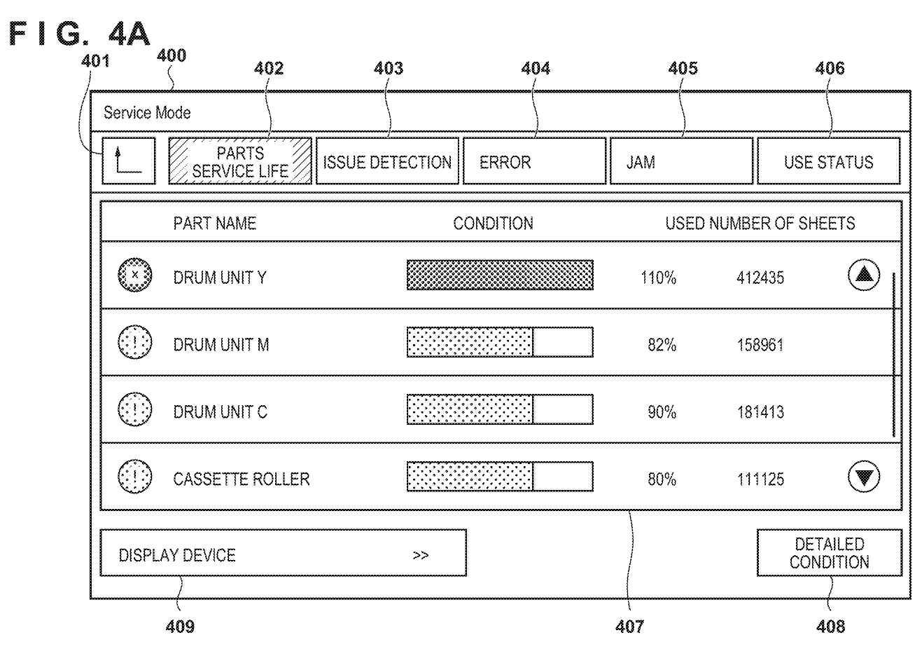

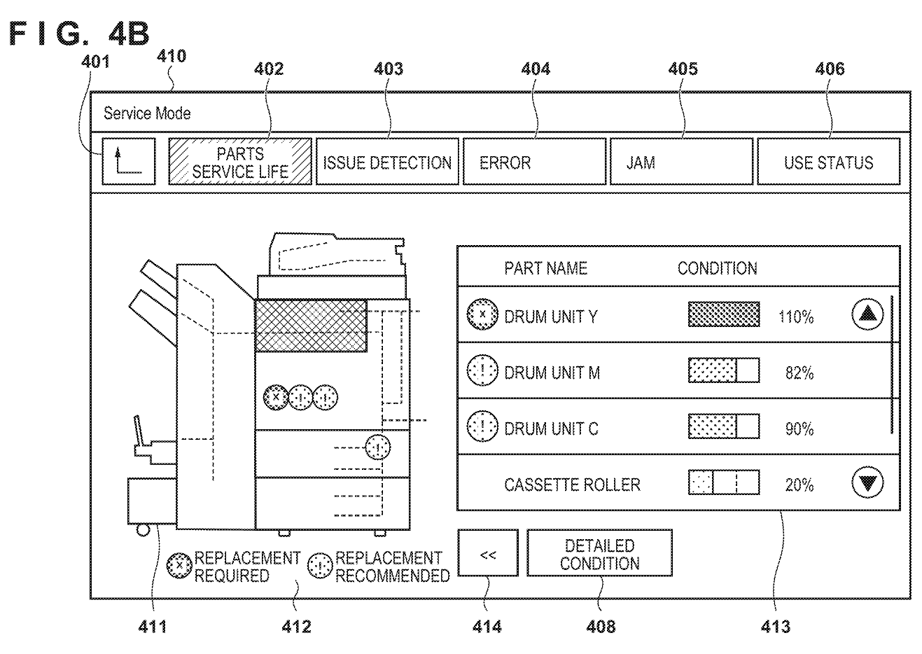

Next, condition monitor screens that display condition information of a plurality of sections in the image processing apparatus 103 for the service technician will be described with reference to FIGS. 4A and 4B-8. The condition information according to the present embodiment is not only information indicating the current condition but also information including history information indicating previous conditions as history. The condition monitor screen is a screen displayed on the operation unit 212 of the image processing apparatus 103. The condition monitor screen, for example, is displayed after transitioning from a service mode top screen (not illustrated). The condition monitor screen is a screen that can display the screens of a plurality of tabs as illustrated in FIGS. 4A and 4B. The condition monitor screen displays by default after transitioning from the service mode top screen is a parts service life screen 400. In a case where an instruction to display the condition monitor screen is detected, the condition monitor screen is displayed based on the data indicating the condition information of the image processing apparatus 103. The condition information of the image processing apparatus 103 is information indicating the condition of each of a plurality of sections inside the image processing apparatus 103 as will be described below with reference to FIGS. 9-13. On the condition monitor screen, the condition information of each of a plurality of sections inside the image processing apparatus 103 is displayed in a list based on the data of FIGS. 9-13. In other words, the condition monitor screen is a list screen displaying a list of the condition information of each of a plurality of sections inside the image processing apparatus 103.

FIG. 4A is a diagram illustrating an example of the parts service life screen 400 displayed as the condition monitor screen. At the upper portion of the screen, as buttons for switching the condition monitor screen, a button 401 for returning to the top screen, a parts service life button 402, an issue detection button 403, an error button 404, a jam button 405, and a use status button 406 are displayed. A detailed parts list 407 is a screen displayed based on the data of FIG. 9 described below, and displays a list indicating the condition of replaceable parts. In each row, the part name, the condition, and the used number of sheets that have been fed after replacement are displayed. The condition is displayed using 4 levels depending on the condition value of the part. In other words, an icon is displayed for the level meter where level 0 is when the value directly after the replacement of a part is indeterminate, level 1 is when the condition value is from 0 to 79%, level 2 is when the condition value is from 80 to 99%, and level 3 is when the condition value is 100% or more. Also, on the right side of the level meter, the current condition value is displayed using a numerical value. The condition value is a higher value when deterioration of the part has advanced, and it is preset so that the value at which replacement is required is 100%. The condition value, for example, is a value calculated using the used number of sheets after replacement, the current value of each part, the resistance value, and the like as parameters and is a value that, in other words, represents the amount of wear and the service life. In a case where the condition value is level 2, a replacement recommended icon is displayed on the left side of the list. The replacement recommended icon is an icon indicating that the corresponding part is near the end of its service life. In FIG. 4A, “Drum unit M” and “Drum unit C” are indicated as being in the replacement recommended state. In a case where the condition value is level 3, a replacement required icon is displayed on the left side of the list. The replacement required icon is an icon indicating that the corresponding part has reached the end of its service life. In FIG. 4A, “Drum unit Y” is indicated as being in the replacement required state. In a case where the service technician has replaced the part and the CPU 201 detects the part replacement, the condition value is put in the no data level 0. Accordingly, neither the replacement required icon nor the replacement recommended icon are displayed for replaced parts from the detailed parts list 407. A detailed condition button 408 is a button for transitioning to a screen (not illustrated) that displays a graph of the change in the condition value of the part selected in the detailed parts list 407. The change in the condition value of a part is, for example, displayed based on the data of FIG. 9 described below. A device display switch button 409 is a button that can receive an instruction to switch to a parts service life screen 410 with a cross-sectional view as illustrated in FIG. 4B.

FIG. 4B is a diagram illustrating an example of the parts service life screen 410 with a cross-sectional view. The parts service life screen 410 with a cross-sectional view is a screen in which a cross-sectional view 411 displaying the entire faulty section is displayed simultaneously with (adjacent to) a simple parts list 413 displaying only a portion of the information of the detailed parts list 407. The buttons 401 to 406 and the detailed condition button 408 are as described with respect to the parts service life screen 400 of FIG. 4A. In the cross-sectional view 411, a conveying path for sheets inside the image processing apparatus 103 is indicated, and the service technician can see whether or not there is an abnormality that could negatively affect use of the main function of the image processing apparatus 103 such as scanning and printing. A legend 412 of various types of abnormalities indicates the types of icons mapped onto the cross-sectional view 411 and the details. For example, types of icons are displayed in accordance with whether or not a part with advanced deterioration needs to be replaced. The cross-sectional view 411, in other words, may be referred to as a cross-sectional view image with icons corresponding to the condition information mapped to each of the sections inside the image processing apparatus 103. In other words, the cross-sectional view 411 is an image displaying a consolidation of the condition information of all of the plurality of sections of the image processing apparatus 103. By looking at this image together with the condition value of each part, the user can understand, at a single time, the condition information relating to all of the plurality of sections inside the image processing apparatus 103 and the associated position inside the image processing apparatus 103. Thus, the user can easily see whether an abnormality has occurred that may negatively affect each function of the image processing apparatus 103.

The simple parts list 413 displays a list corresponding to the detailed parts list 407 with the used number of sheets item removed. In this example, the used number of sheets item is removed, but other items may be removed, or the items of the detailed parts list 407 may remain unchanged and the displayed amount of text may be restricted. In other words, the simple parts list 413 may be referred to as a screen with the information restricted to allow for the simultaneous (adjacent) display of the cross-sectional view 411. The condition, part name, and icon display are as described with respect to the detailed parts list 407 and thus are not described here. A device display switch button 414 is a button that can receive an instruction to switch to the parts service life screen 400. By pressing the device display switch button 409 and the device display switch button 414, the user can, as desired, switch between the parts service life screen 400 and the parts service life screen 410 with a cross-sectional view. In FIG. 4B, in one screen, the simple parts list 413 and the cross-sectional view 411 are arranged side by side. However, as long as the service technician can view them at the same time, the simple parts list 413 and the cross-sectional view 411 may be displayed on different screens.

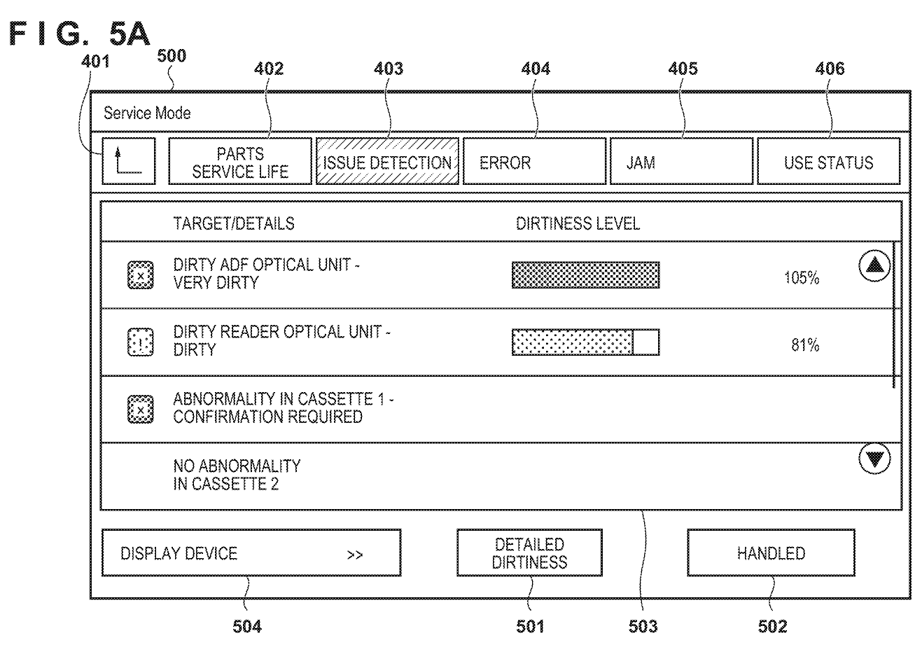

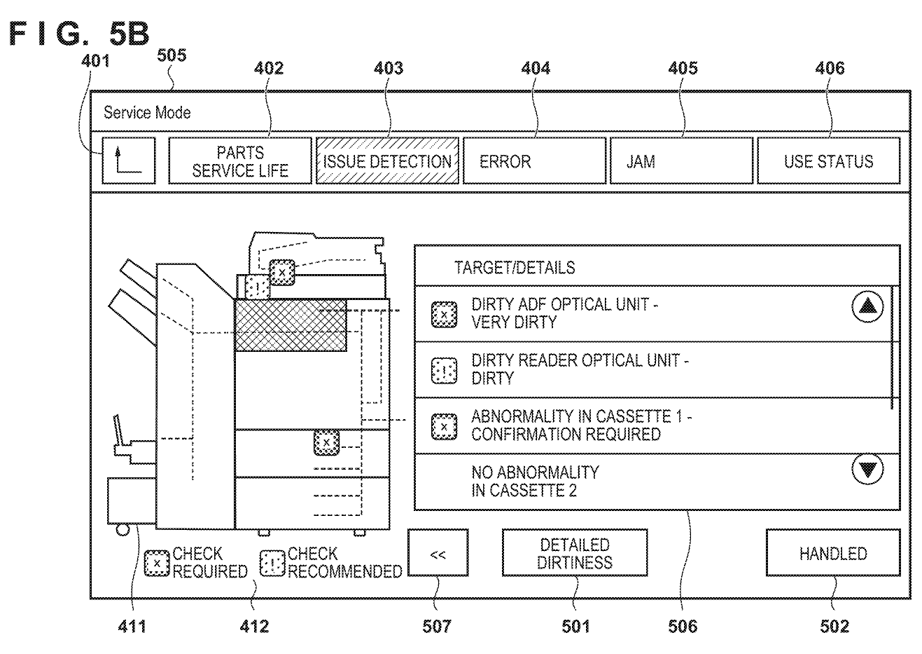

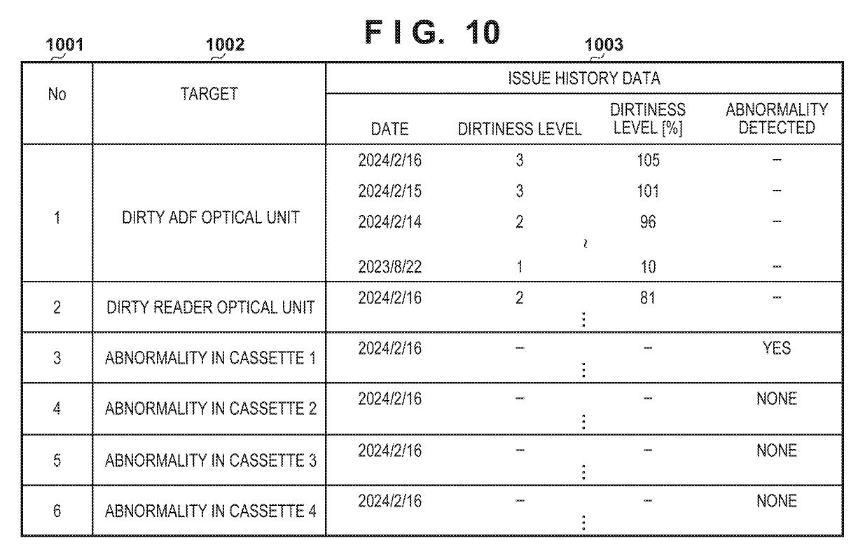

FIG. 5A is a diagram illustrating an example of an issue detection screen 500 displayed when the issue detection button 403 is pressed. The buttons 401 to 406 are as described with respect to the parts service life screen 400 of FIG. 4A. A device display switch button 504 is a button that can receive an instruction to switch to an issue detection screen 505 with a cross-sectional view. A detailed issue list 503 is a screen displayed based on the data of FIG. 10 described below, and displays a list indicating an issue target which the service technician needs to fix and the details. “Dirty ADF optical unit” and “Dirty reader optical unit” are displays for indicating whether or not an optical unit needs to be cleaned. The image processing apparatus 103 detects how dirty a mirror is from the value of the light reflected by the mirror obtained by an optical sensor and the like and displays whether or not action is required by the service technician using an icon of 4 stages of a level meter as with the condition value of the parts service life and a value of the dirtiness level with 100% being a reference value indicating that cleaning is required. For example, in a case where the dirtiness level is indeterminate, a level 0 icon is displayed. In a case where the dirtiness level is from 0 to 79%, a level 1 icon is displayed. In a case where the dirtiness level is from 80 to 99%, a level 2 icon is displayed. In a case where the dirtiness level is 100% or greater, a level 3 icon is displayed. In a case where the dirtiness level is level 2, on the left end of the list, a check recommended icon indicating that cleaning is recommended is displayed. In a case where the dirtiness level is level 3, on the left end of the list, a check required icon indicating that cleaning is required is displayed. Also, each message for the details in the list changes depending on the level. For example, “No data” is displayed for level 0, “Good” is displayed for level 1, “Dirty” is displayed for level 2, and “Very dirty” is displayed for level 3. A detailed dirtiness button 501 is a button for transitioning to a screen (not illustrated) that displays a graph of the change (history) in the dirtiness level of the optical unit selected in the detailed issue list 503. The change in the dirtiness level is, for example, displayed based on the data of FIG. 10 described below.

“Abnormality in cassette” of the detailed issue list 503 is a display indicating whether or not there is an abnormality in each cassette and the details. In a case where misalignment of the regulating plate (guide) mainly for sheets in the cassette is detected, the CPU 201 determines that there is an abnormality in the cassette. Also, the message “Confirmation required” is displayed in a case where there is an abnormality in the cassette, and the message “None” is displayed in a case where there is no abnormality in the cassette. A handled button 502 is a button displayed and controlled to be pressable in a case where a check is recommended or a check is required for an optical unit or a cassette. In a case where the user selects a target optical unit after cleaning the optical unit and presses the handled button 502, the dirtiness level returns to 0. Then, both the check required icon and the check recommended icon are not displayed in the detailed issue list 503. Also, in a case where the user looks at the check required icon, selects the target cassette after checking the cassette, and then presses the handled button 502, the display returns to no abnormality. Then, no abnormality is displayed and the check required icon is not displayed in the detailed issue list 503.

FIG. 5B is a diagram illustrating an example of the issue detection screen 505 with a cross-sectional view. The issue detection screen 505 with a cross-sectional view is a screen in which the cross-sectional view 411 displaying the entire faulty section is displayed simultaneously with (adjacent to) a simple issue list 506 displaying only a portion of the information of the detailed issue list 503. The buttons 401 to 406, the detailed dirtiness button 501, and the handled button 502 are as described with respect to FIG. 4A and with respect to the issue detection screen 500 of FIG. 5A. As in FIG. 4B, in the cross-sectional view 411, a conveying path for sheets is indicated, and the service technician can see whether or not there is an abnormality that could negatively affect use of the main function of the image processing apparatus 103 such as scanning and printing. The legend 412 of various types of abnormalities indicates the types of icons mapped onto the cross-sectional view 411 and the details. For example, types of icons are displayed in accordance with whether or not a check is required due to an issue.

The simple issue list 506 displays a list corresponding to the detailed issue list 503 with the dirtiness level item removed. In this example, the dirtiness level item is removed, but the items of the detailed issue list 503 may remain unchanged and the displayed amount of text may be restricted. In other words, the simple issue list 506 may be referred to as a screen with the information restricted to allow for the simultaneous (adjacent) display of the cross-sectional view 411. The condition, part name, and icon display are as described with respect to the detailed issue list 503 and thus are not described here. A device display switch button 507 is a button that can receive an instruction to switch to the issue detection screen 500. By pressing the device display switch button 504 and the device display switch button 507, the user can, as desired, switch between the issue detection screen 500 and the issue detection screen 505 with a cross-sectional view. In FIG. 5B, in one screen, the simple issue list 506 and the cross-sectional view 411 are arranged side by side. However, as long as the service technician can view them at the same time, the simple issue list 506 and the cross-sectional view 411 may be displayed on different screens.

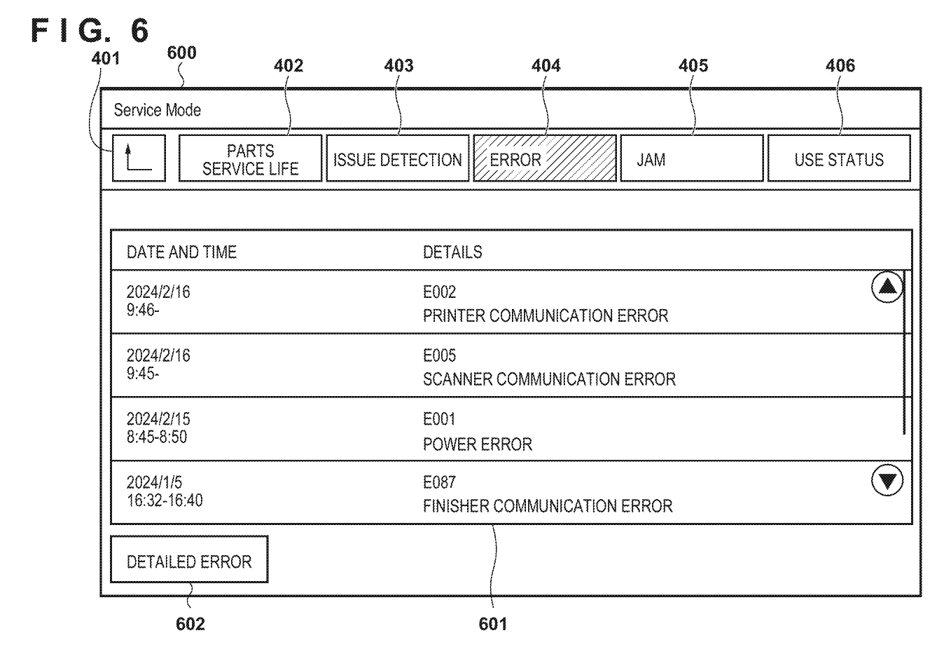

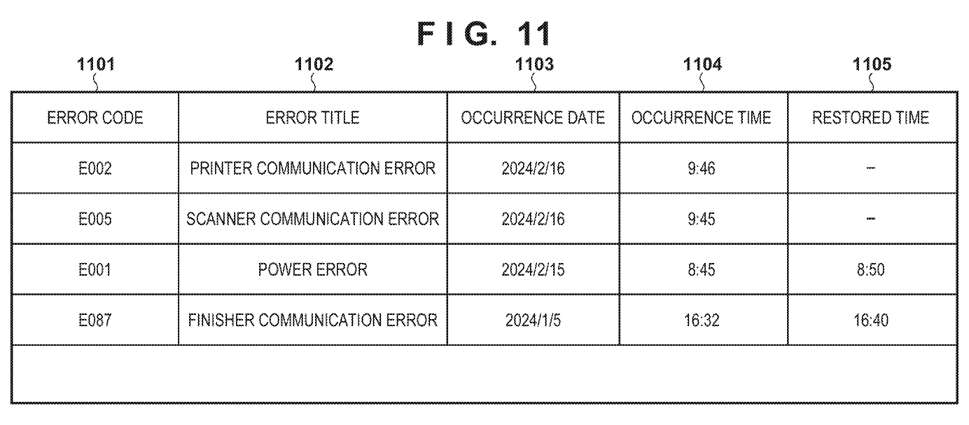

FIG. 6 is a diagram illustrating an example of an error screen 600 displayed when the error button 404 is pressed. The buttons 401 to 406 are as described with respect to the parts service life screen 400 of FIG. 4A. An error list 601 is a screen displayed based on the data of FIG. 11 described below, and displays a list of the history of errors that have occurred in the image processing apparatus 103. The error list 601 displays, for each error, the date and time that the error occurred, the occurrence time, the time that operation was restored, and the error code and corresponding title as the details. The first and second errors without a display of the time restored indicate that the error is still currently in effect. On the other hand, the “8:45 - 8:50” of the power error indicates that the error occurred at 8:45 and operation was restored from the error at 8:50. A detailed error button 602 is a button for transitioning to a screen that displays detailed information (not illustrated) of the error selected in the error list 601.

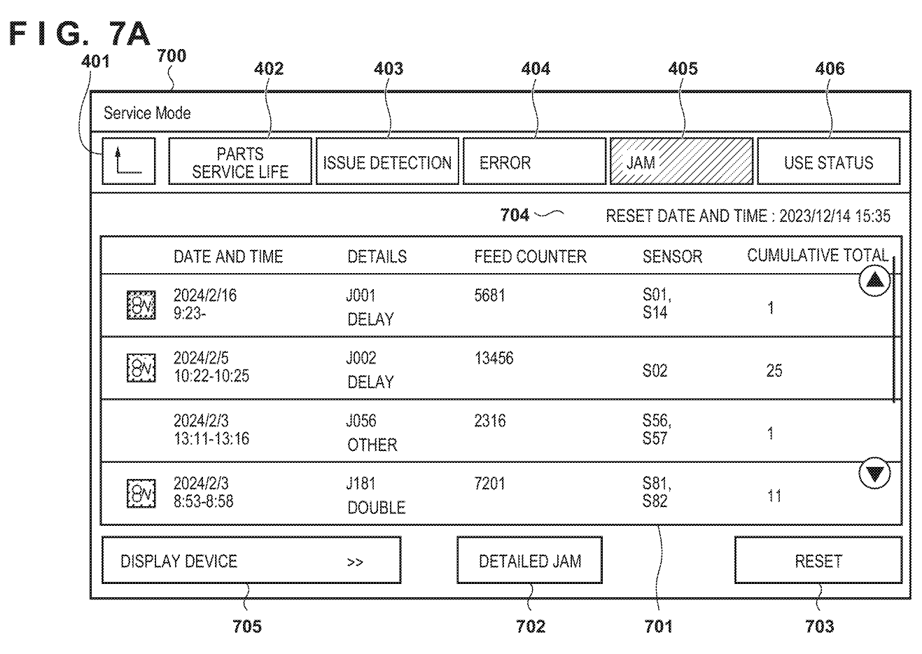

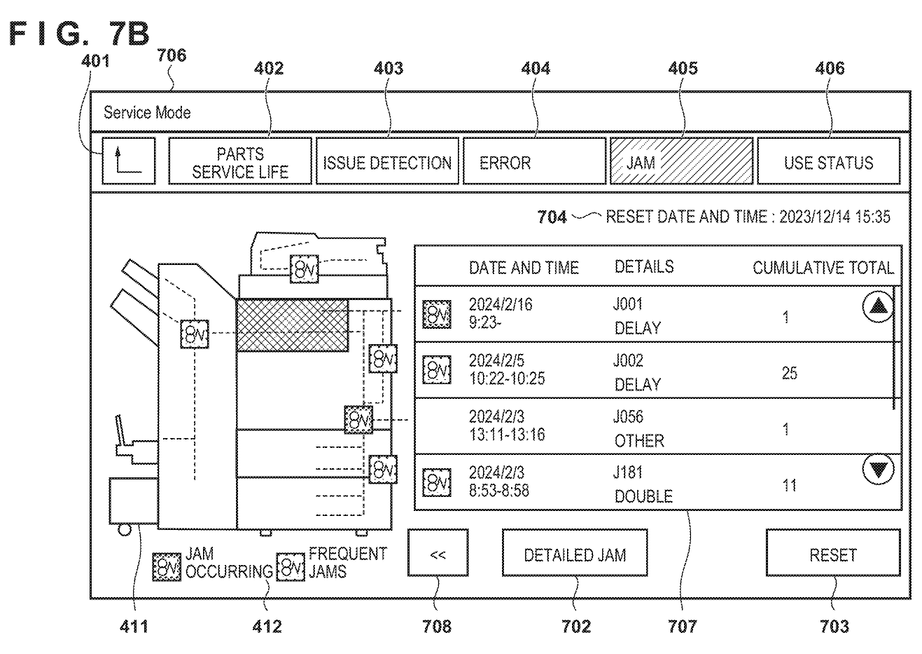

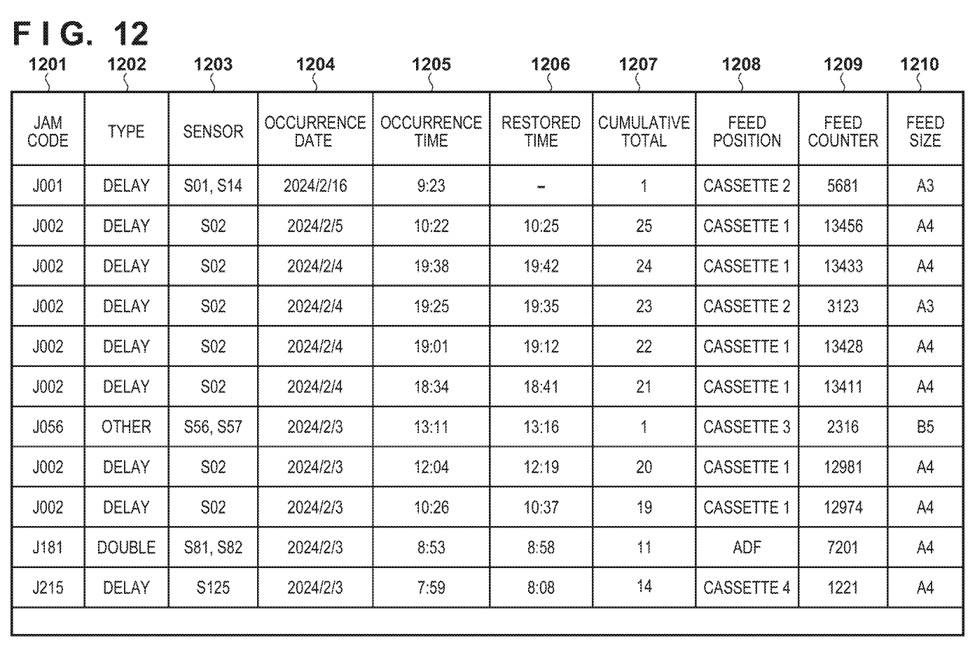

FIG. 7A is a diagram illustrating an example of a jam screen 700 displayed when the jam button 405 is pressed. The buttons 401 to 406 are as described with respect to the parts service life screen 400 of FIG. 4A. A device display switch button 705 is a button that can receive an instruction to switch to a jam screen 706 with a cross-sectional view. A detailed jam list 701 is a screen displayed based on the data of FIG. 12 described below, and displays a list of jam history. The detailed jam list 701 displays, for each jam occurrence, the date and time of the jam, the occurrence time, the time that operation was restored, the jam code and jam type as details, the feed counter, the sensor number, and the cumulative total of the same jam code. The first jam without a display of the time restored indicates that the jam is still currently in effect, and an icon indicating that there is currently a jam is displayed on the left end of the list. A jam with a jam history such as the second and fourth jam in which the cumulative total is equal to or greater than a specific number is determined to be a frequently-occurring jam, and an icon indicating a frequently-occurring jam is displayed on the left end of the list. In the present example, if the number of times is 10 or greater, it is determined to be a frequently-occurring jam. Also, in a case where there are multiple histories of the same jam code, only the latest one is displayed in the list. This makes it easier for the user to understand the type of the jam that has occurred. A detailed jam button 702 is a button for transitioning to a screen (not illustrated) indicating the details of the jam selected in the detailed jam list 701. The details of the jam are displayed based on the data of FIG. 12, for example. A reset button 703 is a button for clearing the jam history currently being displayed. This is used in a case where the user has finished checking on a jam currently in effect or a frequently-occurring jam and wishes to delete the notification, for example. When the reset button 703 is pressed, the date and time of the reset date and time 704 is updated, and only the jam history from the reset date and time 704 onward is displayed in the detailed jam list 701.

FIG. 7B is a diagram illustrating an example of the jam screen 706 with a cross-sectional view. The jam screen 706 with a cross-sectional view is a screen in which the cross-sectional view 411 displaying the entire faulty section is displayed simultaneously with (adjacent to) a simple jam list 707 displaying only a portion of the information of the detailed jam list 701. The buttons 401 to 406, the detailed jam button 702, and the reset button 703 are as described with respect to FIG. 4A and with respect to the jam screen 700 of FIG. 7A. As in FIG. 4B, in the cross-sectional view 411, a conveying path for sheets is indicated, and the service technician can see whether or not there is an abnormality that could negatively affect use of the main function of the image processing apparatus 103 such as scanning and printing. The legend 412 of various types of abnormalities indicates the types of icons mapped onto the cross-sectional view 411 and the details. For example, types of icons are displayed in accordance with whether or not the section is a section where there is currently a jam or section where jams frequently occur.

The simple jam list 707 displays a list corresponding to the detailed jam list 701 with the feed counter and sensor items removed. In this example, the feed counter and sensor items are removed, but other items may be removed, or the items of the detailed jam list 701 may remain unchanged and the displayed amount of text may be restricted. In other words, the simple jam list 707 may be referred to as a screen with the information restricted to allow for the simultaneous (adjacent) display of the cross-sectional view 411. The condition, part name, and icon display are as described with respect to the detailed jam list 701 and thus are not described here. A device display switch button 708 is a button that can receive an instruction to switch to the jam screen 700. By pressing the device display switch button 705 and the device display switch button 708, the user can, as desired, switch between the jam screen 700 and the jam screen 706 with a cross-sectional view. In FIG. 7B, in one screen, the simple jam list 707 and the cross-sectional view 411 are arranged side by side. However, as long as the service technician can view them at the same time, the simple jam list 707 and the cross-sectional view 411 may be displayed on different screens.

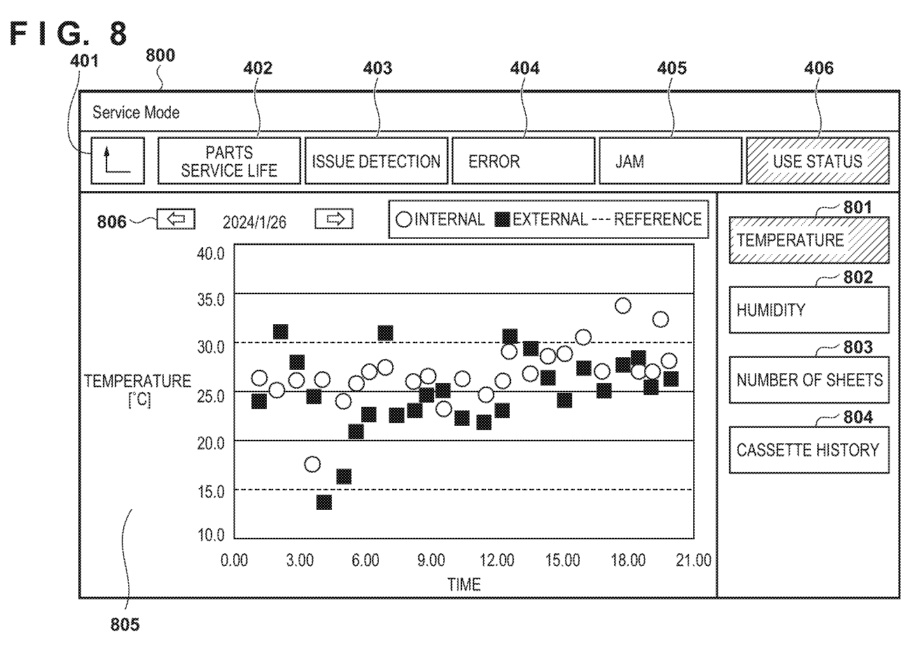

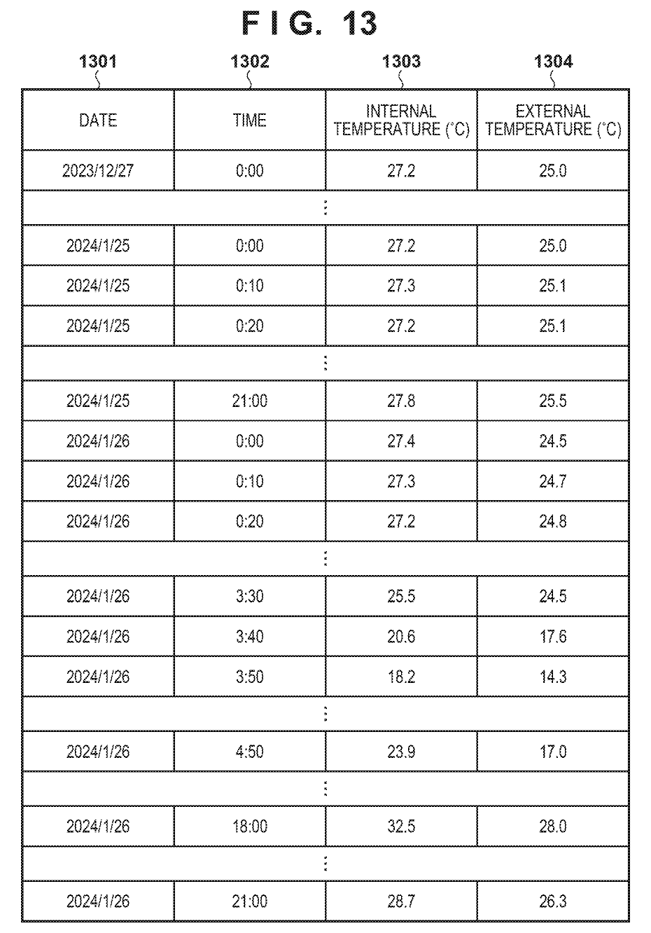

FIG. 8 is a diagram illustrating an example of a use status screen 800 displayed when the use status button 406 is pressed. On the right portion of the screen, a temperature button 801, a humidity button 802, a number of sheets button 803, and a cassette history button 804 are displayed for transitioning to each use status screen. FIG. 8 illustrates a temperature change screen displayed when the temperature button 801 of the use status screen 800 is pressed. A temperature change graph 805 is displayed based on the data of FIG. 13 described below, the change over one day of the temperature inside and outside the device at 10 minute intervals being represented with the vertical axis representing temperature (°C) and the horizontal axis representing time. A switch date button 806 displays the date of the displayed graph and can display data up to one month previous by being pressed. In the temperature change graph 805, the reference temperature is indicated by a broken line, and in a case where the temperature is outside of the reference, the user can determine that the environment needs to be re-examined. Also, the user can check whether the temperature change is the cause of the error or jam by comparing the error screen 600 of FIG. 6 or the jam screen 700 of FIG. 7A with the same time period on the temperature change screen of FIG. 8, for example. When the humidity button 802, the number of sheets button 803, or the cassette history button 804 is pressed, the detailed screen of each item is transitioned to. A graph showing the change based on each data is displayed on the humidity details screen (not illustrated), the number of sheets details screen (not illustrated), and the cassette history details screen (not illustrated).

FIG. 9 is a diagram illustrating an example of data indicating the condition information used in display of the parts service life screen. In FIG. 9, the data indicating the condition information is history data used for displaying a list of the parts service life information. Item 901 indicates the sort order of the parts. Part name 902 indicates the part name. Condition history data 903 indicates the history data of the condition of each part. As the history data 903 of the condition of a part, the date on which data was obtained, the condition level as a part condition value, the condition value (%), and a used number of sheets fed after part replacement are stored per day. Also the history data 903 of the condition of a part is used for displaying a detailed condition screen displayed when the detailed condition button 408 of FIGS. 4A and 4B is pressed. The history data of FIG. 9 is an example, and items other than the items indicated in FIG. 9 may be included.

The part name 902 and the condition history data 903 of FIG. 9 are displayed in order of the item 901 in the detailed parts list 407 of FIG. 4A and the simple parts list 413 of FIG. 4B. However, as described above, the amount of information displayed in the simple parts list 413 may be less than the amount of information displayed in the detailed parts list 407. In a case where the service technician detects a part replacement, since it is after the part has been replaced, the condition level of the replaced part is set to level 0 which is the value for an indeterminate condition. The data of the condition value (%) and the used number of sheets at this time is set to a blank state. As described above, the history data of the parts service life of FIG. 9 is used for displaying the information of the parts service life in each of the detailed parts list 407 and the simple parts list 413.

FIG. 10 is a diagram illustrating an example of data indicating the condition information used in display of the issue detection screen. In FIG. 10, the data indicating the condition information is history data used for displaying issue detection information. Item 1001 indicates the sort order of the issue. Target 1002 indicates the name of the issue which is the target. Issue history data 1003 indicates the history data of each issue. As the issue history data 1003, in the case of an optical unit, the date on which data was obtained, the dirtiness level as how dirty it is, and the dirtiness level (%) are stored for each day. Also, the issue history data 1003 for the optical unit is used for displaying a detailed dirtiness screen displayed when the detailed dirtiness button 501 of FIGS. 5A and 5B is pressed. As the issue history data 1003, in the case of a cassette, the date on which data was obtained and whether or not an abnormality has been detected are stored for each day. The history data of FIG. 10 is an example, and items other than the items indicated in FIG. 10 may be included.

Each issue and corresponding condition of FIG. 10 are displayed in order of the item 1001 in the detailed issue list 503 of FIG. 5A and the simple issue list 506 of FIG. 5B. However, as described above, the amount of information displayed in the simple issue list 506 may be less than the amount of information displayed in the detailed issue list 503. In a case where a press of the handled button 502 by the service technician is detected, the value is updated in the following manner for the issue that has been handled. For example, in a case where the handled issue is dirtiness of the optical unit, the value of the dirtiness level is set to level 0, the indeterminate condition. The data for the dirtiness level (%) at this time is set to a blank state. Also, for example, in a case where the handled issue is for the cassette, the abnormality detected is updated to none. As described above, the history of issue detection of FIG. 10 is used for displaying issue detection information in each of the detailed issue list 503 and the simple issue list 506.

FIG. 11 is a diagram illustrating an example of data indicating the condition information used in display of the error screen. In FIG. 11, the data indicating the condition information is history data used for displaying error information. Error code 1101 indicates an error code for identifying the error. Error title 1102 indicates the title of the error corresponding to the error code 1101. Occurrence date 1103 indicates the date on which the error occurred. Occurrence time 1104 indicates the time at which the error occurred. Restored time 1105 indicates the time at which the error was resolved. The data stored as illustrated in FIG. 11 is displayed in the error list 601 of FIG. 6 sorted by the occurrence date 1103 and the occurrence time 1104 in descending order. The history data of FIG. 11 is an example, and items other than the items indicated in FIG. 11 may be included. Note that though not illustrated in FIG. 11, the content corresponding to each error code is stored in the HDD 204 and displayed as a detailed error screen when the detailed error button 602 of FIG. 6 is pressed. As described above, the error history of FIG. 11 is used for displaying error information.

FIG. 12 is a diagram illustrating an example of data indicating the condition information used in display of the jam screen. In FIG. 12, the data indicating the condition information is history data used for displaying jam information. Jam code 1201 indicates a jam code for identifying a jam. Type 1202 indicates the type of the jam corresponding to the jam code. For example, a jam in which a sheet is not detected by a sensor after an expected amount of time or greater has elapsed is indicated as the type “DELAY” (delay). Also, a jam in which a sensor continuously detects a sheet for an expected amount of time or greater is indicated as the type “STNRY” (stationary). Also, a jam in which a sensor of an Auto Document Feeder (ADF) detects a double feed is indicated as the type “DOUBLE” (double feed). Sensor 1203 indicates the sensor number that detected the jam. Occurrence date 1204 indicates the date on which the jam occurred. Occurrence time 1205 indicates the time at which the jam occurred. Restored time 1206 indicates the time at which the jam was resolved. Cumulative total 1207 indicates the cumulative total number of times a jam of the same jam code has occurred. The number of times a jam has occurred since the reset date and time 704 of FIGS. 7A and 7B is counted up as the cumulative total 1207. In a case where the cumulative number of times is equal to or greater than a specific number of times (for example, 10 times or greater), it is determined to be a frequently-occurring jam, and an icon indicating frequently-occurring jam is displayed on the cross-sectional view 411 of FIG. 7B and the jam screen 700 of FIG. 7A. Feed position 1208 indicates the sheet feed position where the jam occurred. Feed counter 1209 indicates the number of sheets fed from the feed position. Feed size 1210 indicates the size of the fed sheet. The history data of FIG. 12 is an example, and items other than the items indicated in FIG. 12 may be included.

The history data of FIG. 12 is displayed in the detailed jam list 701 of FIG. 7A and the simple jam list 707 of FIG. 7B sorted by the occurrence date 1204 and the occurrence time 1205 in descending order. However, as described above, the amount of information displayed in the simple jam list 707 may be less than the amount of information displayed in the detailed jam list 701. The difference in the display of history data is that only the latest jam of the same jam code is displayed. The history of the same jam code is displayed on a detailed jam screen (not illustrated) displayed when the detailed jam button 702 of FIGS. 7A and 7B is pressed. Note that in a case where the reset button 703 is pressed, the jam history from before the date and time when the reset button 703 is pressed is deleted. As described above, the history data of FIG. 12 is used for displaying the jam information in the detailed jam list 701 and the simple jam list 707.

FIG. 13 is a diagram illustrating an example of data indicating the condition information used in display of the use status screen. In FIG. 13, the data indicating the condition information is temperature history data used for displaying temperature change information. Date 1301 indicates the date temperature data was obtained, with one month's worth of history data being stored. Time 1302 indicates the time temperature data was obtained, with history data being stored in 10-minute increments, for example. Internal temperature 1303 indicates temperature data obtained by a thermometer (not illustrated) installed inside the image processing apparatus 103. External temperature 1304 indicates temperature data obtained by a thermometer (not illustrated) installed outside the image processing apparatus 103. The history data of FIG. 13 is an example, and items other than the items indicated in FIG. 13 may be included. As described above, the temperature history data of FIG. 13 is used for displaying the temperature change graph 805 on the temperature change screen of FIG. 8. Note that in the present embodiment, though not illustrated, humidity history data used for displaying humidity change information is data configured in a similar manner to the temperature history data including data such as date, time, internal humidity, and external humidity. Also, the number of sheets data used for displaying the change in the number of sheets information is data including the date, time, and number of sheets, for example. Also, the cassette history data is data including information of the cassette used for each job, for example.

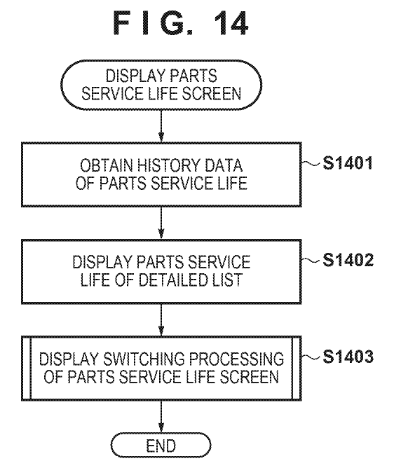

FIG. 14 is a flowchart illustrating display control processing of the parts service life screen. The program relating to the processing of the present processing is stored in the HDD 204 of the image processing apparatus 103 and is loaded into the RAM 202 and executed by the CPU 201. The present flowchart is started based on an instruction to display the condition monitor screen from the service mode top screen being received from the service technician. As an example, the processing of FIG. 14 will be described below as the processing relating to the parts service life screen of FIGS. 4A and 4B. However, the processing of FIG. 14 can also be applied to the issue detection screen of FIGS. 5A and 5B and the jam screen of FIGS. 7A and 7B, and the same effects can be achieved.

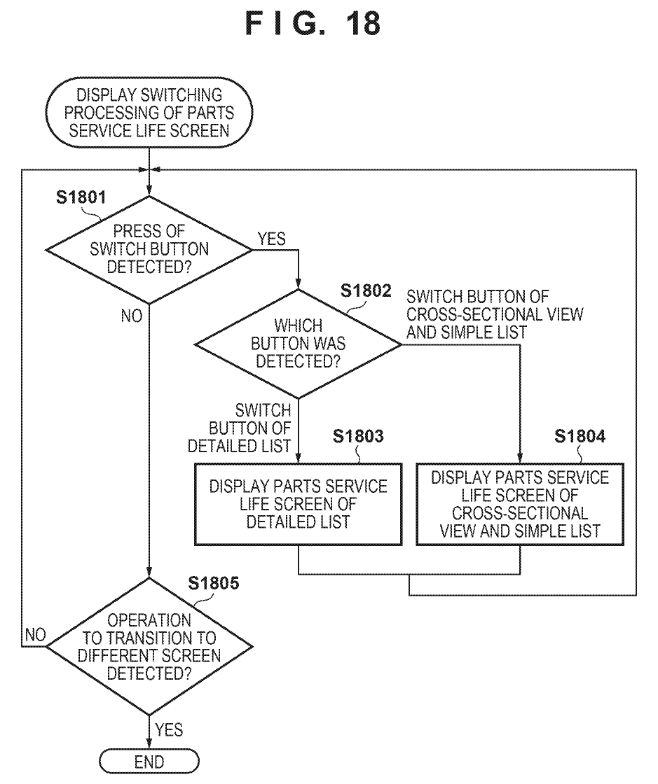

In S1401, the CPU 201 obtains the history data of the parts service life illustrated in FIG. 9 stored in the HDD 204. In S1402, the CPU 201 displays the condition information indicated by the history data obtained in S1401 on the parts service life screen 400 of FIG. 4A. For example, the part name 902 and the condition history data 903 of FIG. 9 is displayed in order of the item 901 in the detailed parts list 407 of FIG. 4A. In S1403, the CPU 201 executes display switching processing of the parts service life screen illustrated in FIG. 18 and thereafter ends the processing of FIG. 14.

FIG. 18 is a flowchart illustrating display switching processing of the parts service life screen. In S1801, the CPU 201 determines whether or not a press of the device display switch button 409 or the device display switch button 414 has been detected. Here, in a case where it is determined that neither a press of the device display switch button 409 nor a press of the device display switch button 414 has been detected, the processing advances to S1805.

In S1805, the CPU 201 determines whether or not an operation to transition to a different screen has been detected. An operation to transition to a different screen refers to a press of the detailed condition button 408, for example. In a case where it is determined that an operation to transition to a different screen has been detected, the processing of FIG. 18 ends, and a screen corresponding to the detected operation is transitioned to. In a case where it is determined that an operation to transition to a different screen has not been detected, the processing from S1801 is repeated.

In S1801, in a case where it is determined that either a press of the device display switch button 409 or a press of the device display switch button 414 has been detected, the processing advances to S1802.

In S1802, the CPU 201 determines which device display switch button was detected in S1801. In a case where the detected button is determined to be the device display switch button 409, in S1804, the CPU 201 displays the parts service life screen 410 with a cross-sectional view and thereafter repeats the processing from S1801. On the other hand, in a case where the detected button is determined to be the device display switch button 414, in S1803, the CPU 201 displays the parts service life screen 400 and thereafter repeats the processing from S1801.

As described above, according to the present embodiment, control is performed in such a manner that it is possible to, as desired, switch between the screen displayed based on the history data illustrated in FIG. 9 and the screen displaying a portion of the history data illustrated in FIG. 9 and a cross-sectional view.

Also, in a case where the processing of FIG. 14 is applied to the issue detection screen, in S1401, the history data illustrated in FIG. 10 is obtained, and in S1402, the issue detection screen of FIG. 5A is displayed. Then, in S1403, control is performed in such a manner that it is possible to, as desired, switch between the screen of FIG. 5A displayed based on the history data illustrated in FIG. 10 and the screen of FIG. 5B displaying a portion of the history data illustrated in FIG. 10 and a cross-sectional view.

Also, in a case where the processing of FIG. 14 is applied to the jam screen, in S1401, the history data illustrated in FIG. 12 is obtained, and in S1402, the jam screen of FIG. 7A is displayed. Then, in S1403, control is performed in such a manner that it is possible to, as desired, switch between the screen of FIG. 7A displayed based on the history data illustrated in FIG. 12 and the screen of FIG. 7B displaying a portion of the history data illustrated in FIG. 12 and a cross-sectional view.

According to the configuration described above, a service technician can simultaneously check the abnormality list information and the cross-sectional view displaying the entire mapped abnormal sections. Thus, the service technician can comprehensively understand the abnormal sections in the entire apparatus while looking at the abnormality list information, allowing user-friendliness to be improved.

### Second Embodiment

The differences between the second embodiment and the first embodiment will be described below. An abnormality that can be detected by a service technician by looking at a cross-sectional view may not be detected with a display of only a list. For example, in a case where there is an abnormal section that does not fit in the displayed screen, the service technician may not detect the abnormal section by just looking at the screen. This is because the abnormal section is outside of the screen display target region and is not seen by the user unless they scroll the screen. To prevent such a situation, in the present embodiment, in the case of an abnormal section that does not fit in the displayed screen, priority is given to the display of a screen in which a cross-sectional view and a list are displayed simultaneously (adjacent to each other).

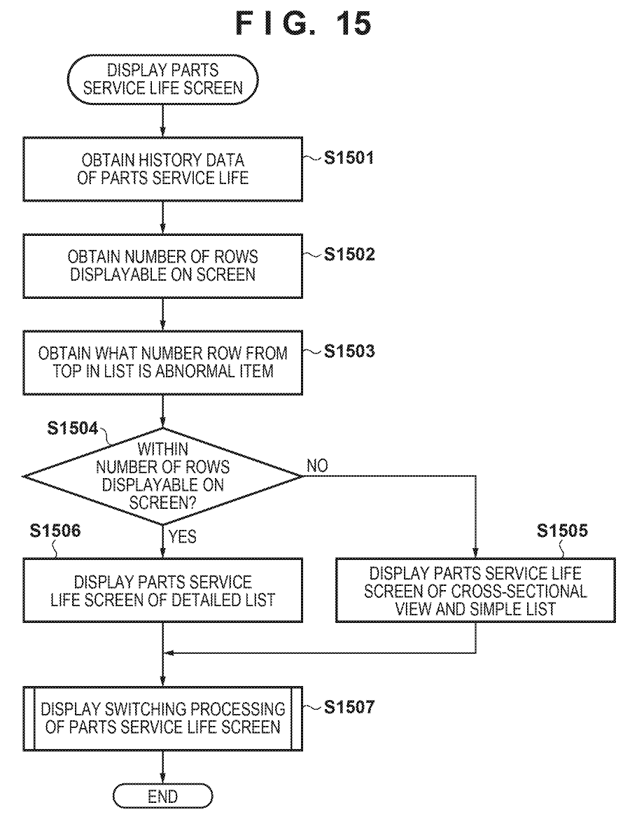

FIG. 15 is a flowchart illustrating display control processing for determining which screen from among the parts service life screen 400 and the parts service life screen 410 with a cross-sectional view to prioritize for display based on whether the row where the abnormal section of the device is displayed is in the portion lower than the number of rows displayed on the screen at one time. The program relating to the processing of the present processing is stored in the HDD 204 of the image processing apparatus 103 and is loaded into the RAM 202 and executed by the CPU 201. The present flowchart is started based on an instruction to display the condition monitor screen from the service mode top screen being received from the service technician. As an example, the processing of FIG. 15 will be described below as the processing relating to the parts service life screen of FIGS. 4A and 4B. However, the processing of FIG. 15 can also be applied to the issue detection screen of FIGS. 5A and 5B and the jam screen of FIGS. 7A and 7B.

In S1501, the CPU 201 obtains the history data of the parts service life illustrated in FIG. 9 stored in the HDD 204. In S1502, the CPU 201 obtains information indicating the number of rows that can be displayed on the screen at one time (hereinafter referred to as displayable number of rows) of the detailed parts list 407 on the parts service life screen. This information may be stored in the HDD 204, for example. For example, in FIG. 4A, the detailed parts list 407 has 4 rows, and thus in S1502, information indicating 4 rows is obtained.

In S1503, the CPU 201 obtains information indicating what number row from the top in the list is the row indicating the abnormal section of the apparatus based on the parts service life history data illustrated in FIG. 9. For example, in the case of FIG. 9, since the condition value 110% of the drum unit Y is greater than the value 100% indicating that replacement is required, this is determined to be an abnormal section of the apparatus. As illustrated in FIG. 9, the condition value 110% of the drum unit Y is the first row from the top of the list. Thus, in this case, in S1503, information indicating the first row is obtained.

In S1504, the CPU 201 determines whether or not the abnormal section row indicated by the information obtained in S1503 is located within the displayable number of rows obtained in S1502. In a case where it is determined that the abnormal section row is located within the displayable number of rows, in S1506, the CPU 201 displays the parts service life screen 400 of FIG. 4A, that is, a parts service life screen including the detailed parts list 407. On the other hand, in a case where it is determined that the abnormal section row is not located within the displayable number of rows, the processing advances to S1505. The abnormal section row being not located within the displayable number of rows refers to the abnormal section row being in the fifth row or lower from the top in the list. In S1505, the CPU 201 displays the parts service life screen 410 of FIG. 4B, that is, a parts service life screen including the cross-sectional view 411 and the simple parts list 413. Accordingly, in a case where the abnormal section row is not shown in the list, the user can look at the cross-sectional view 411 to realize that it is there.

After S1506 and S1505, in S1507, the CPU 201 executes display switching processing of the parts service life screen of FIG. 18. After S1507, the processing of FIG. 18 ends.

As described above, according to the present embodiment, control is performed to prioritize display of either the parts service life screen of FIG. 4A or the parts service life screen of FIG. 4B based on the location of the row indicating the abnormal section in the list indicated by the history data of FIG. 9.

Also, in a case where the processing of FIG. 15 is applied to the issue detection screen, in S1501, the history data illustrated in FIG. 10 is obtained. Also, in S1504 to S1506, control is performed to prioritize display of either the issue detection screen of FIG. 5A or the issue detection screen of FIG. 5B based on the location of the row indicating the abnormal section in the list indicated by the history data of FIG. 10.

Also, in a case where the processing of FIG. 15 is applied to the jam screen, in S1501, the history data illustrated in FIG. 12 is obtained. Also, in S1504 to S1506, control is performed to prioritize display of either the jam screen of FIG. 7A or the jam screen of FIG. 7B based on the location of the row indicating the abnormal section in the list indicated by the history data of FIG. 12.

According to a configuration such as that described above, the service technician can easily see an abnormality that could possibly have been missed if only a list was displayed and can perform the work without missing any abnormal sections.

Also, as described above, in S1504, whether or not the abnormal section row indicated by the information obtained in S1503 is located within the displayable number of rows obtained in S1502 is determined. However, a different determination may be performed. For example, in a case where the number of rows showing the history data of FIG. 10 is greater than the displayable number of rows obtained in S1502, the processing may advance to S1506.

### Third Embodiment

The differences between the third embodiment and the first and second embodiments will be described below. In the present embodiment, the screen to prioritize for display is determined based on the screen size.

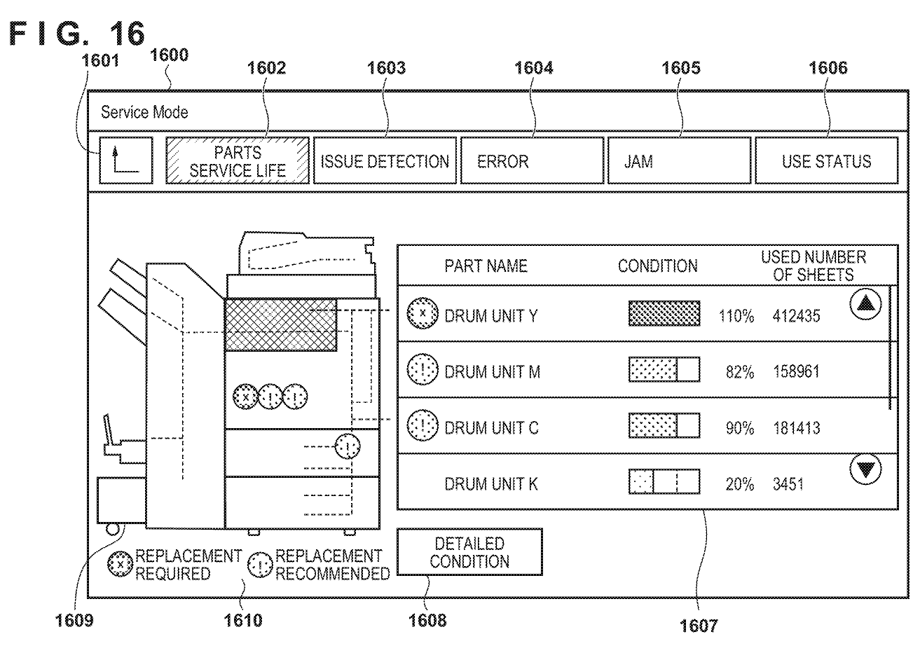

FIG. 16 is a diagram illustrating an example of a parts service life screen 1600 displayed in a case where the size of the screen of the operation unit 212 is larger than a predetermined size. Buttons 1601 to 1606 and a detailed condition button 1608 are the same as described relating to the buttons 401 to 406 and the detailed condition button 408 and thus will not be described. A cross-sectional view 1609 and a legend 1610 are the same as described relating to the cross-sectional view 411 and the legend 412 and thus will not be described. A detailed parts list 1607 is similar to the detailed parts list 407 and displays the part name, the condition, and the used number of sheets. The configuration of the parts service life screen 1600 of FIG. 16 is similar to that of the parts service life screen 410 with a cross-sectional view of FIG. 4B and is able to simultaneously (adjacently) display the cross-sectional view and the parts list. However, since the size of the screen of the operation unit 212 is larger than the predetermined size, the detailed parts list 1607 is displayed without removing any amount of information as with the simple parts list 413 of FIG. 4B. In other words, the parts service life screen 1600 is configured as a screen on which the detailed parts list 407 of FIG. 4A and the cross-sectional view 411 are simultaneously displayed. Thus, the service technician can easily see the abnormal section information with one screen without needing to transition to a different screen.

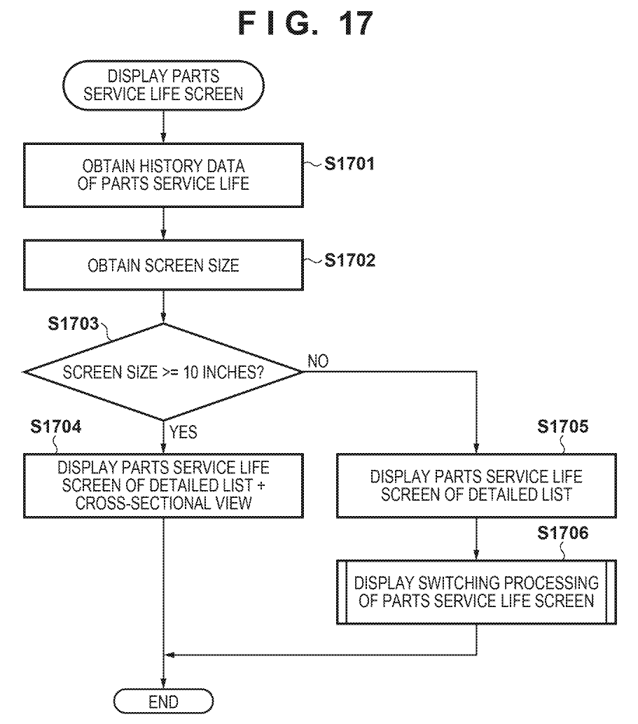

FIG. 17 is a flowchart illustrating display control processing to determine which screen to prioritize for display based on the size of the screen of the operation unit 212. The present flowchart is started based on an instruction to display the condition monitor screen from the service mode top screen being received from the service technician. As an example, the processing of FIG. 17 will be described below as the processing relating to the parts service life screen of FIGS. 4A and 4B. However, the processing of FIG. 17 can also be applied to the issue detection screen of FIGS. 5A and 5B and the jam screen of FIGS. 7A and 7B.

In S1701, the CPU 201 obtains the history data of the parts service life illustrated in FIG. 9 stored in the HDD 204. In S1702, the CPU 201 obtains the size information of the screen of the operation unit 212. The size information of the screen may be stored in the HDD 204, for example.

In S1703, the CPU 201 determines whether or not the size of the screen of the operation unit 212 is equal to or larger than the predetermined size based on the size information of the screen obtained in S1702. Here, for example, the predetermined size is 10 inches. In a case where it is determined that the size of the screen of the operation unit 212 is equal to or larger than the predetermined size, in S1704, the CPU 201 displays the parts service life screen 1600 illustrated in FIG. 16 simultaneously (adjacently) displaying the cross-sectional view and the detailed parts list and thereafter ends the processing of FIG. 17. Accordingly, in a case where the screen size is large, the service technician can be made to simultaneously check the list of detailed information of the abnormalities together with the cross-sectional view with the entire abnormal sections mapped. On the other hand, in a case where it is determined that the size of the screen of the operation unit 212 is not equal to or larger than the predetermined size, in S1705, the CPU 201 displays the parts service life screen 400 illustrated in FIG. 4A with the detailed parts list displayed with the cross-sectional view not displayed. In S1706, the CPU 201 executes display switching processing of the parts service life screen of FIG. 18. After S1706, the processing of FIG. 17 ends. Accordingly, in a case where the screen size is small, first, the service technician can be made to check the list of detailed information of the abnormalities. At this time, the service technician can appropriately switch to the screen of FIG. 4B.

As described above, according to the present embodiment, control is performed to prioritize display of either the parts service life screen of FIG. 4A or the parts service life screen of FIG. 16 based on the size of the screen of the operation unit 212. In other words, control is performed to prioritize display of either a parts service life screen displaying a detailed parts list without displaying a cross-sectional view or a parts service life screen simultaneously (adjacently) displaying a cross-sectional view and a detailed parts list based on the size of the screen of the operation unit 212.

Also, in a case where the processing of FIG. 17 is applied to the issue detection screen, in S1701, the history data illustrated in FIG. 10 is obtained. Also, in S1703 to S1705, control is performed to prioritize display of either an issue detection screen displaying a detailed issue list without displaying a cross-sectional view or an issue detection screen simultaneously (adjacently) displaying a cross-sectional view and a detailed issue list based on the size of the screen of the operation unit 212.

Also, in a case where the processing of FIG. 17 is applied to the jam screen, in S1701, the history data illustrated in FIG. 12 is obtained. Also, in S1703 to S1705, control is performed to prioritize display of either a jam screen displaying a detailed jam list without displaying a cross-sectional view or a jam screen simultaneously (adjacently) displaying a cross-sectional view and a detailed jam list based on the size of the screen of the operation unit 212.

With such a configuration, a layout that is optimal for the screen size can be displayed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-071747, filed Apr. 23, 2025, which is hereby incorporated by reference herein in its entirety.

What is claimed is:

1. An image processing apparatus comprising:
at least one memory and at least one processor which function as:
an obtaining unit configured to obtain condition information indicating a condition of each of a plurality of sections inside the image processing apparatus; and
a display control unit configured to perform control to display a list screen displaying a list of the condition information obtained by the obtaining unit on a display unit,
wherein the display control unit performs control of display to enable switching between a first list screen displaying a list of the condition information together with consolidated display of the condition information so that conditions of all of the plurality of sections can be displayed, and a second list screen displaying a list of the condition information without consolidated display of the condition information.

2. The image processing apparatus according to claim 1, wherein the at least one memory and the at least one processor further function as
a first reception unit configured to receive an instruction for switching from the first list screen to the second list screen,
wherein in a case where the first reception unit receives the instruction for switching to the second list screen, the display control unit performs control to switch display from the first list screen to the second list screen.

3. The image processing apparatus according to claim 2, wherein the at least one memory and the at least one processor further function as
a second reception unit configured to receive an instruction for switching from the second list screen to the first list screen,
wherein in a case where the second reception unit receives the instruction for switching to the first list screen, the display control unit performs control to switch display from the second list screen to the first list screen.

4. The image processing apparatus according to claim 1, wherein
in a case where an instruction to display the list screen displaying a list of the condition information is received, the display control unit performs control to display the first list screen or the second list screen.

5. The image processing apparatus according to claim 4, wherein
in a case where the instruction to display the list screen is received, the display control unit performs control to display the first list screen if all the condition information cannot be displayed as a list at one time on the display unit.

6. The image processing apparatus according to claim 5, wherein
in a case where the instruction to display the list screen is received, the display control unit performs control to display the first list screen if all the condition information cannot be displayed as a list at one time on the display unit and furthermore a portion of the condition information corresponding to a specific section among the plurality of sections is not displayed in the list in the display.

7. The image processing apparatus according to claim 5, wherein
in a case where the instruction to display the list screen is received, the display control unit performs control to display the second list screen if all the condition information can be displayed as a list at one time on the display unit.

8. The image processing apparatus according to claim 4, wherein
in a case where the instruction to display the list screen is received, the display control unit performs control to display the second list screen if a size of the display unit is smaller than a predetermined size.

9. The image processing apparatus according to claim 8, wherein
in a case where the instruction to display the list screen is received, the display control unit performs control to display the first list screen if the size of the display unit is the predetermined size or larger.

10. The image processing apparatus according to claim 9, wherein
in a case where the size of the display unit is the predetermined size or larger, an information amount of the condition information displayed as a list on the first list screen is not less than an information amount of the condition information displayed as a list on the second list screen.

11. The image processing apparatus according to claim 1, wherein
an information amount in a list of the condition information displayed on the first list screen is less than an information amount in a list of the condition information displayed on the second list screen.

12. The image processing apparatus according to claim 1, wherein
an image including the plurality of sections mapped inside the image processing apparatus is displayed as the consolidated display of the condition information.

13. The image processing apparatus according to claim 12, wherein
a list of the condition information and the image are displayed adjacent to each other on the first list screen.

14. The image processing apparatus according to claim 12, wherein
the image processing apparatus is a printer.

15. The image processing apparatus according to claim 14, wherein
the condition information is information indicating whether or not replacement of a part is required, and an icon indicating that replacement of the part is required is mapped on the image.

16. The image processing apparatus according to claim 14, wherein
the condition information is information indicating a problem, and an icon indicating the problem is mapped on the image.

17. The image processing apparatus according to claim 14, wherein
the condition information is information indicating a jam, and an icon indicating the jam is mapped on the image.

18. A method executed by an image processing apparatus comprising:
obtaining condition information indicating a condition of each of a plurality of sections inside the image processing apparatus; and
performing control to display a list screen displaying a list of the obtained condition information on a display unit,
wherein control is performed of display to enable switching between a first list screen displaying a list of the condition information together with consolidated display of the condition information so that conditions of all of the plurality of sections can be displayed, and a second list screen displaying a list of the condition information without consolidated display of the condition information.

19. A non-transitory computer-readable storage medium storing a program configured to cause a computer of an image processing apparatus to function to:
obtain condition information indicating a condition of each of a plurality of sections inside the image processing apparatus; and
perform control to display a list screen displaying a list of the obtained condition information on a display unit,
wherein control is performed of display to enable switching between a first list screen displaying a list of the condition information together with consolidated display of the condition information so that conditions of all of the plurality of sections can be displayed, and a second list screen displaying a list of the condition information without consolidated display of the condition information.
